(19) United States
(12) Patent Application Publication
(10) Pub. No.: US 2003/0057027 A1
(43) Pub. Date: Mar. 27, 2003

(54) Mast for a fork lift

(76) Inventors: Stan J. Simpson, San Antonio, TX (US); Mark James Dodd, Seneca, SC (US)

Correspondence Address: John R. Posthumus, Esq., LeBoeuf, Lamb, Greene & MacRae, L.L.P., Suite 2000, 633 Seventeenth Street, Denver, CO, 80202, US

(21) Appl. No.: 09/960,712

(22) Filed: Sep. 21, 2001

(51) Int. Cl. B66F 9/08; B66F 9/06

(52) U.S. Cl. 187/230; 187/226; 187/406

(57) ABSTRACT

One aspect of the present invention includes rail and carriage assembly combination that provides improved efficient operation. A rail is provided that has an inside surface that includes a straight back surface and an angled front surface. A carriage assembly is provided that includes upper rollers that are canted. Preferably the upper rollers are canted to match the angle of the angled front surface of the rail when a load is applied to the carriage assembly. As to fore/aft loads, the present invention provides a rail and carriage assembly design that causes the upper rollers of the carriage assembly to contact the front inside surface of the rail. As to offset loads, the present invention provides a rail and carriage assembly design that provides for, the rotation of the carriage assembly's rollers in the area of lateral contact caused by the offset load and the translation of the rail relative to the rollers in the area of lateral contact to be in the same direction when the carriage assembly is raised or lowered with an offset load. Another aspect of the present invention includes reducing the width of a portion of the inner rails to allow for integral stacking of the inner rails to minimize lost load of the mast thus minimizing the counterweight required on the body of the fork lift.

### BACKGROUND OF THE INVENTION

Fork lifts are motorized devices that are used to carry a variety of tangible items. Typically, a fork lift includes a mast located on the front of the fork lift. A mast includes one or more rail sections. Each rail section includes two rails, each having an inside surface. The two rails of a rail section are spaced apart and positioned parallel such that the inside surface of each rail pair faces each other. The fork lift is capable of vertically moving the rail sections to enable an operator of the fork lift to raise, lower and carry products. A carriage assembly, which may include forks used to hold the product being raised or lowered, is in moveable contact with the inside surfaces of the rail pair. In this regard, the carriage assembly typically includes rollers that moveably contact the inside surface of the rail section. Finally, the body (which excludes the mast) of the fork lift is required to have a counterweight to balance the body of the fork lift with the combine weight of the mast and the anticipated weight of the tangible items to be carried by the mast.

A mast may vary in many ways, including the height that a fork may be raised and the amount of visibility that an operator may have looking through the mast. These factors combine to determine the design of mast that is used for a particular application. There are several configurations of masts that are known depending on the application. One style of mast is called simplex. A simplex mast is a two-stage design that is low-cost to design and build and simple to operate. A simplex mast includes two sections, an inner section and an outer section. The inner section is operatively connected to the outer section to allow the inner section to telescope inside the outer section and out from the outer section. A simplex mast's lifting height is the total length of the inner section and outer section when the inner section is fully extended from the outer section. As a result, the lifting height of the simplex mast is limited because of the lack of more than two telescoping sections. The simplex mast offers relatively high visibility through the mast because the mast has only two sections.

A second style of mast is called a duplex mast. A duplex mast is a two stage mast that utilizes a two-stage design as described above for the simplex mast and a lifting stage. The lifting stage allows the rails of the mast to be raised and lowered relative to the fork lift without moving the inside section relative to the outside section. A duplex mast's lifting height is the total length of the inner section and outer section when the inner section is fully extended from the outer section. Moreover, the lifting stage improves the functionality of the fork lift because the carriage may be moved the entire length of the inner section without increasing the overall height of the mast. However, the lifting stage adds to manufacturing cost of the mast. The addition of the lifting stage further reduces the visibility of the operator through the mast.

A third style of mast, and the most common, is a three-stage mast called a triplex mast. The triplex mast utilizes three sections, an outer section, a middle section, and an inner section. The middle section is operatively connected to the outer section to allow the middle section to telescope inside the outer section and out from the outer section. The inner section is operatively connected to the middle section to allow the inner section to telescope inside the middle section and out from the middle section. The triplex mast also includes the lifting stage that is described above as to the duplex mast. The lifting height of the triplex mast is determined by the combined distance of the inner section, middle section and outer section when the inner section is filly extended from the middle section, and the middle section is fully extended from the inner section. As a result, the lifting height of the triplex mast is limited because of the lack of more than three telescoping sections. The lifting stage further reduces the visibility of the operator through the mast.

A final common mast type is a quad mast that uses four sections. The quad mast includes four rail sections, an inner section, a first middle section, a second middle section and an outer section. The second middle section is operatively connected to the outer section to allow the second middle section to telescope inside the outer section and out from the outer section. The first middle section is operatively connected to the second middle section to allow the first middle section to telescope inside the second middle section and out from the second middle section. The inner section is operatively connected to the first middle section to allow the inner section to telescope inside the first middle section and out from the first middle section. The quad mast also includes the extra lifting stage of the duplex mast. The advantage of the quad mast is that the quad mast can reach higher than the other masts described above with the same length sections. A quad mast's lifting height is the total length of the inner section, first middle section, second middle section and outer section when the inner section is fully extended from the first middle section, the first middle section is fully extended from the second middle section, and the second middle section is fully extended from the inner section. An operator's visibility through the mast is at its worse when the inner mast is fully telescoped within the first middle section, the first middle section is fully telescoped within the second middle section, and the second middle section is fully telescoped within the outer section. The lifting stage further reduces the visibility of the operator through the mast.

Generally, the inner surface of the rails of a rail section are either both straight or both angled. Referring to FIG. 1, a cross section of a rail 2 having two straight sides 4 is shown. If the inner surface of the rails are both straight, there is poor contact between the inner surface and the upper roller of the carriage assembly. In situations wherein the rails shown in FIG. 1 are used, an offset load on a carriage assembly operatively attached to the rails will cause a lateral load on the carriage assembly's rollers that is applied to the back corner of the rails. As a consequence, when a carriage assembly is raised or lowered with an offset load, the direction of rotation of the rollers in the area of lateral contact and the translation of the rail section relative to the rollers in the area of contact are in the opposite direction. Referring to FIG. 2, when the carriage assembly is raised, the rotation of the carriage assembly's roller 9 is in the clockwise direction Z and the translation of the rail 40 relative to the roller 9 is in the direction M. Thus, the direction of rotation of the roller 9 at the point of contact Y is in the opposite direction as the translation of the rail 40 in the direction M. Referring to FIG. 3, when the carriage assembly is lowered, the rotation of the carriage assembly's roller 9 is in the counterclockwise direction W and the translation of the first rail 40 relative to the roller 9 is in the direction N. Thus, the direction of rotation of the roller 9 at the point of contact Y is in the opposite direction as the translation of the first rail 40 in the direction N. This proves to be inefficient in operation because the rotation and translation in the area of lateral contact oppose each other.

Referring to FIGS. 4 and 5, an example of a three rail stack-up is shown. An outer rail section R1 includes an outer cross bar U1 that connects the outer rail R1 to the accompanying outer rail (not shown). The middle rail R2 includes a middle cross bar U2 that connects the middle rail R2 to the accompanying middle rail (not shown). Finally, an inner rail R3 is shown. In this design, a gap G is required to give clearance between the middle cross bar U2 and the inner rail R3. Thus, the inner rail R3 must be located a distance away from the center of mass of the body of the fork lift. Consequently, additional counterweight is required on the body of the forklift that is not required if the distance of the gap G is decreased. Increased counterweight on the fork lift decreases the energy efficiency of the fork lift and increases the cost of production.

### SUMMARY OF THE INVENTION

The present invention satisfies, to a great extent, the foregoing and other needs not currently satisfied by existing fork lift masts by a mast designed that provides improved efficiency of operation and improved operation with offset loads. One aspect of the present invention includes rail and carriage assembly combination that provides improved efficient operation. A rail is provided that has an inside surface that includes a straight back surface and an angled front surface. A carriage assembly is provided that includes upper rollers that are canted. Preferably the upper rollers are canted to match the angle of the angled front surface of the rail when a load is applied to the carriage assembly.

Thus, when the carriage assembly is loaded, the carriage assembly applies a combination of lateral and fore/aft forces on the rails depending on the weight distribution of the load on the carriage assembly. For example, a load on the carriage assembly will cause a fore/aft force to be applied to the inner surface area of the rails by the carriage assembly's rollers, and an offset (i.e., off center) load on the carriage assembly will cause a lateral force to be applied to the inner surface of the rails by the carriage assembly's rollers.

As to fore/aft loads, the present invention provides a rail and carriage assembly design that causes the upper rollers of the carriage assembly to contact the front inside surface of the rail. More specifically, the rail deflection causes the upper rollers of the carriage assembly to fully contact the front inside surface of the rail section. Consequently, the roller contact with the rail is improved, contact stresses are reduced, and the operating efficiency of the fork lift is improved.

As to offset loads, the present invention provides a rail and carriage assembly design that provides for, the rotation of the carriage assembly's rollers in the area of lateral contact caused by the offset load and the translation of the rail relative to the rollers in the area of lateral contact to be in the same direction when the carriage assembly is raised or lowered with an offset load. Consequently, the operating efficiency of the fork lift is improved and the operation of the mast with offset loads is improved.

Another aspect of the present invention includes reducing the width of the inner rails to allow for integral stacking of the inner rails to minimize lost load of the mast thus minimizing the counterweight required on the body of the fork lift. In this regard, the width of the rear side of the inner rails of the mast is reduced to decrease the effective thickness of the inner rail. As a result, the overall thickness of the combination of rails with the inner rail, when integrally stacked, is reduced and the inner rail is located closer to the center of mass of the body of the fork lift. Thus, the overall thickness of the mast is reduced, which allows for a reduction in counterweight required on the body of the forklift to offset the lifted load. Consequently, the operating efficiency of the fork lift is improved.

### DESCRIPTION OF THE DRAWINGS

FIG. 1 shows a cross section of a prior art rail having two straight sides.

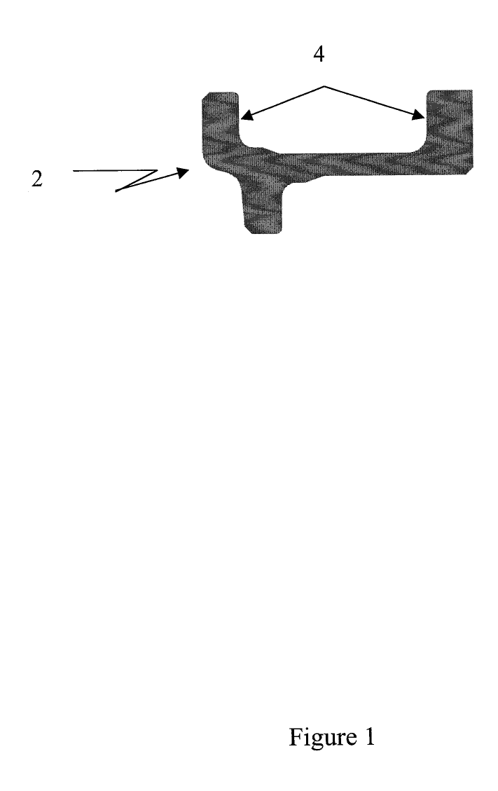

FIG. 2 shows a side view of the rotation of the carriage assembly's roller and the translation of the rail relative to the roller when the carriage assembly is raised.

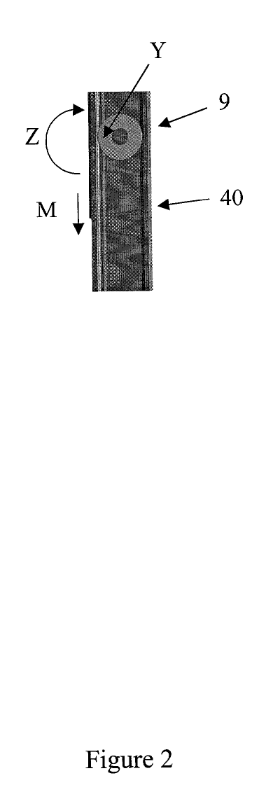

FIG. 3 shows a side view of the rotation of the carriage assembly's roller 9 and the translation of the first rail relative to the roller when the carriage assembly is lowered.

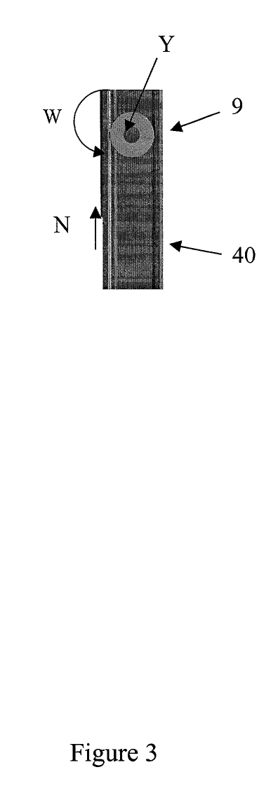

FIG. 4 shows a perspective view of a prior art three rail stack-up.

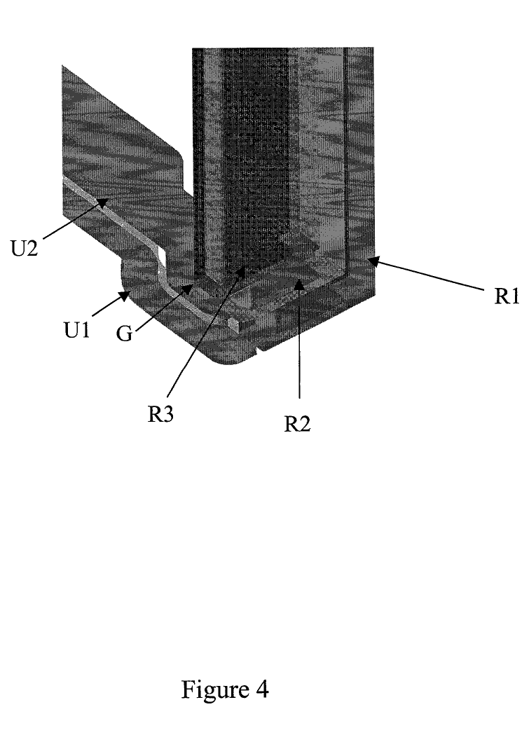

FIG. 5 shows a perspective view of a prior art three rail stack-up.

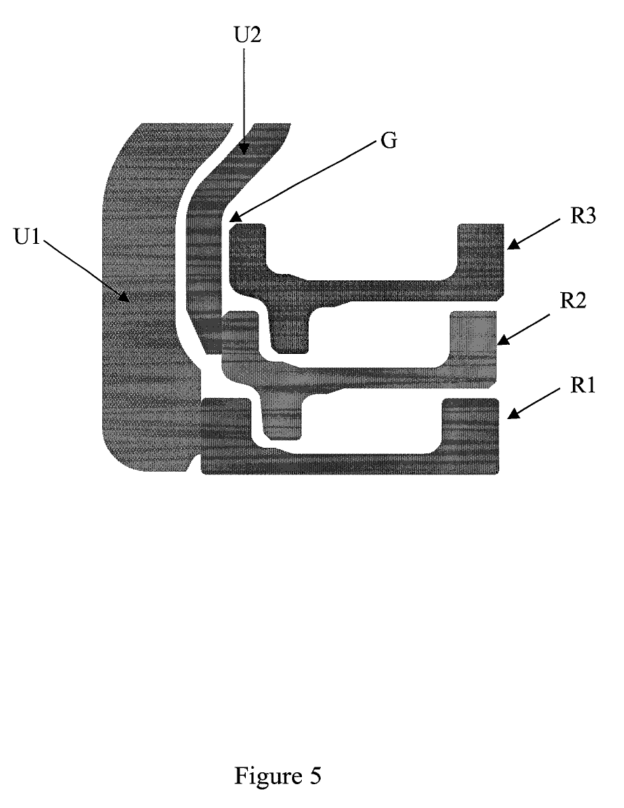

FIG. 6 shows a cross-section view of a rail section having an inside surface that includes a straight back surface and an angled front surface.

FIG. 7 shows a perspective view of a carriage assembly that includes a first upper roller, a second upper roller, a first lower roller, and a second lower roller.

FIG. 8 shows a cross section view of the inner surface of the rail.

FIG. 9 shows a cross section view of the carriage assembly.

FIG. 10 shows a top cross-section view of the second upper roller having a difference in angle relative to, the front inside surface of the rail section when the carriage assembly is unloaded.

FIG. 11 shows a top cross-section view of the rail section deflecting forward because the back of the rail section is more restrained from rotation than the front of the rail section when the carriage assembly is loaded.

FIG. 12 shows a top cross-section view of the lower roller in full contact with the inside back surface of the rail section during both loaded and unloaded conditions.

FIG. 13 shows a perspective view of the second upper roller and the second lower roller in contact with one of the rail pair of the rail section.

FIG. 14 shows a perspective view of the second upper roller acting against the front inner surface of the first rail and the first lower roller (not shown) acting on the back inner surface of the second rail.

FIG. 15 shows a perspective view of the second upper roller (not shown) acting against the front inner surface of the first rail and the first lower roller acting on the back inner surface of the second rail.

FIG. 16 shows a top cross-section view of the second upper roller acting (i.e., has a point of contact) against the front inner corner of the first rail at point Y.

FIG. 17 shows a side view of the rotation of the second upper roller and the translation of the first rail relative to the second upper roller when the carriage assembly is raised.

FIG. 18 shows a side view of the rotation of the second upper roller and the translation of the first rail relative to the second upper roller when the carriage assembly is lowered.

FIG. 19 shows a side view of the reduction of the width of the rear side of the inner rails to allow for integral stacking of the inner rails to minimize lost load of the mast.

FIG. 20 shows a perspective view of the mast wherein the width of the inner rails has been reduced to allow for integral stacking of the inner rails to minimize lost load of the mast.

FIG. 21 shows a bottom view of the mast wherein the width of the inner rails has been reduced to allow for integral stacking of the inner rails to minimize lost load of the mast.

### DETAILED DESCRIPTION OF THE INVENTION

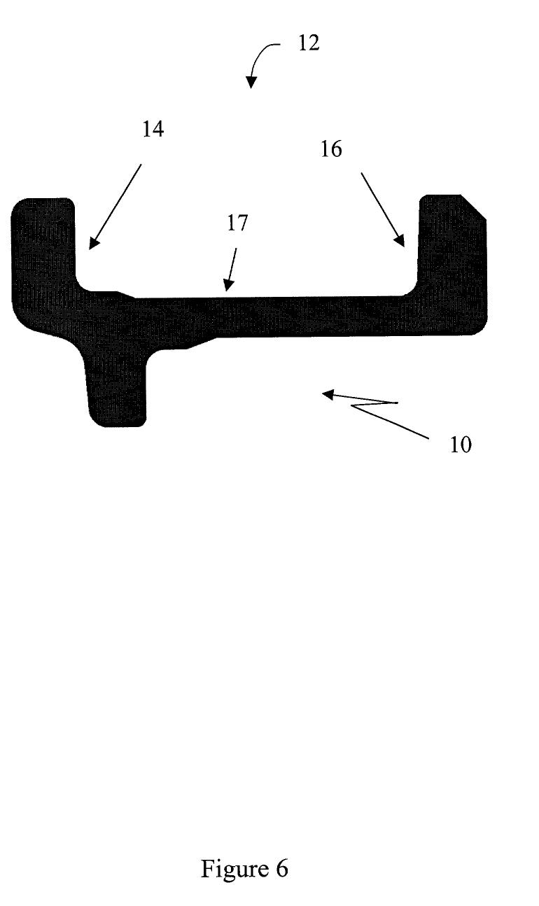

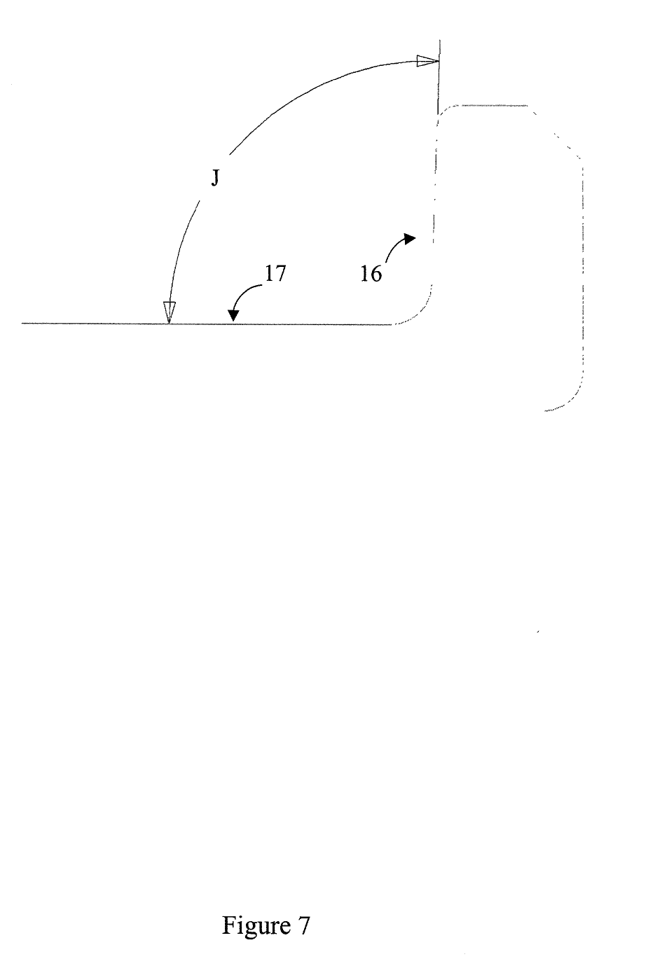

The present invention is for use with fork lifts that include at least one rail section. Referencing FIG. 6, one aspect of the present invention includes a rail section 10 having an inner surface 12 that includes a straight back surface 14, an angled front inner surface 16 and an lateral inner surface 17. Referencing FIG. 7, the angle K of the front surface 16 is determined by measuring the angle between the front inner surface 16 and lateral inner surface 17. Preferably the angle K is in the range of about 91.5° to about 92.5°. More preferably, the angle K is about 92°.

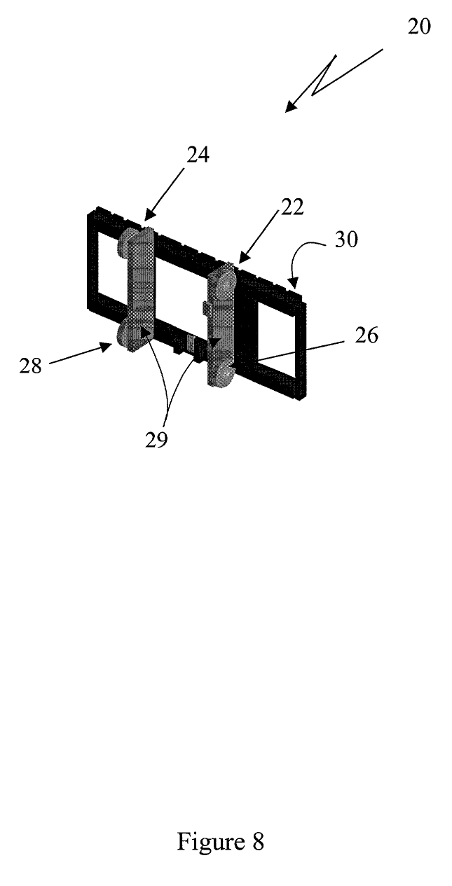

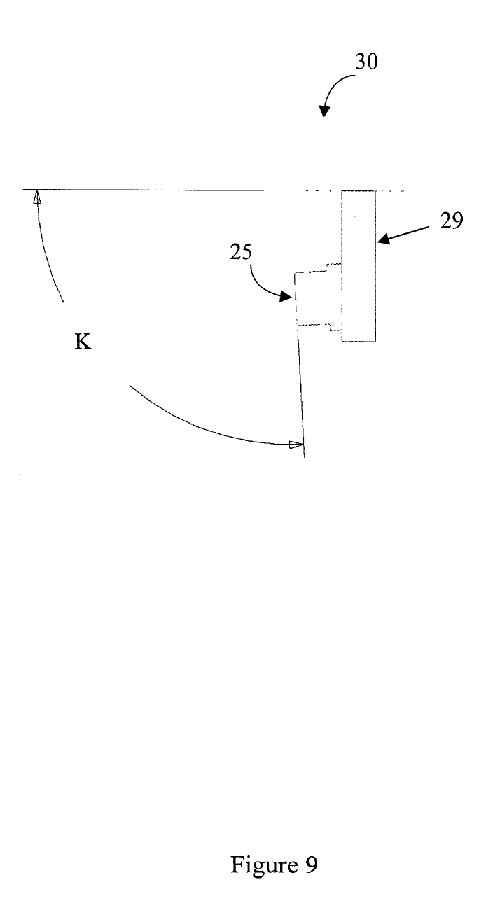

The rail section 10 shown in FIG. 6 is a cross section of the rail section 10 and includes an inner surface 12 that accommodates a carriage assembly 20 as shown in FIG. 8. The carriage assembly 20 includes a first upper roller 22, a second upper roller 24, a first lower roller 26, a second lower roller 28, and a front face 30. The first upper 20 roller 22, the second upper roller 24, the first lower roller 26, and the second lower roller 28 each have an axle (not shown) on which the particular roller rotates. The axial (not shown) is attached a vertical support member 29. The first upper roller 22 and the first lower roller 26 are mated with the inner surface 12 of one of the rails of a rail section and the second upper roller 24 and the second lower roller 28 are mated with the inner surface 12 of the opposite rail of the rail section to allow the carriage assembly 20 to move along the rail section. The first upper roller 22 and the second upper roller 24 are angled or canted relative to the front face 30. Referencing FIG. 9, the angle of the second upper roller 24 is determined by the angle J between the axle 25 and the front face 30. Although not shown in FIG. 9, the angle of the first upper roller 22 is similarly determined. Preferably the angle J is in the range of about 92.5° to about 93.5°. More preferably, the angle K is about 93°.

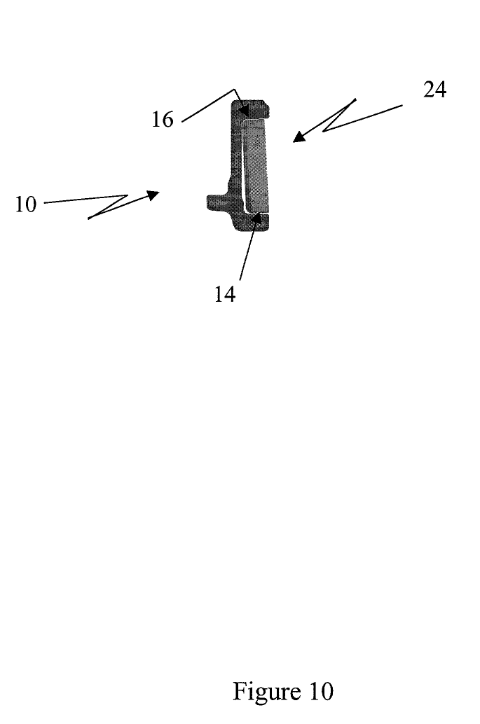

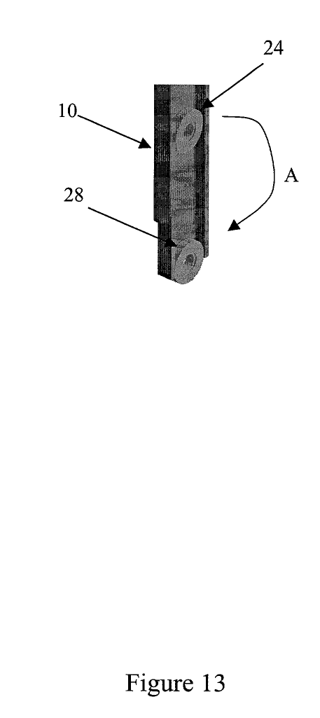

Referencing FIGS. 10-13, the fore-aft movement of the rail section 10 of the present invention is described. Preferably the first upper roller 22 and the second upper roller 24 are canted to match the angle of the front inside surface 16 of the rail section 10 when a load is applied to the carriage assembly 20. The first lower roller 26 and the second lower roller 28 are not angled so that the first lower roller 26 and the second lower roller 28 match the straight surface on the back inside surface 14 of the rail section 10. Referencing FIG. 13, the second upper roller 24 and the second lower roller 28 are shown in contact with one of the rail pair of the rail section 10. Generally, when a load is applied to the front face 30 of the carriage 20, a clockwise movement in the direction A is caused on the rollers 22, 24, 26, 28. In this regard, the first upper roller 22 and the second upper roller 24 act against the front inside surface 16 of the rail section 10, and the first lower roller 26 and second lower roller 28 act against the back inside surface 14 of the rail section 10.

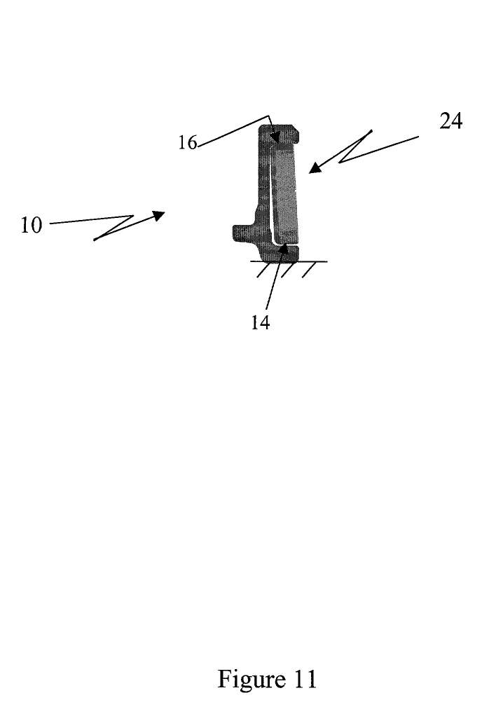

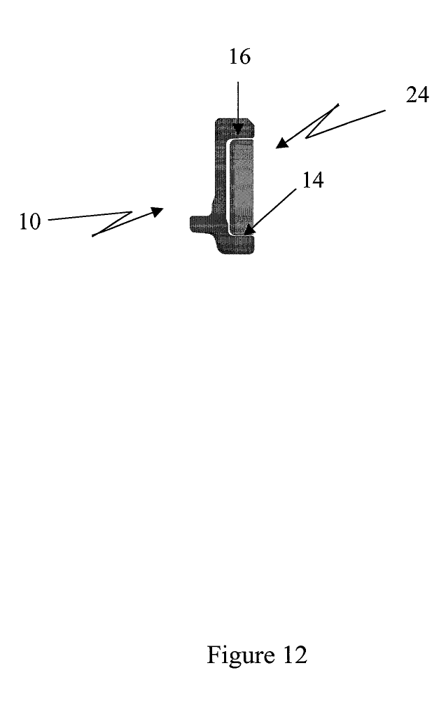

As shown in FIG. 10, when the carriage assembly 30 (not shown) is unloaded, the first upper roller 22 (not shown) and second upper roller 26 are designed to have a difference in angle relative to, the front inside surface 16 of the rail section 10. Preferably, the difference in angle relative to the front inside surface 16 of the rail section 10, i.e., the difference between angle J and angle K, is approximately a 1° difference. As shown in FIG. 11, when the carriage assembly 30 (not shown) is loaded, the rail section 10 will deflect forward because the back of the rail section 10 is more restrained from rotation than the front of the rail section 10. As a consequence, the applied load causes the upper rollers 22 and 24 to react on the front inside surface 16 of the rail section 10. More specifically, the rail deflection causes the first upper roller (not shown) and the second upper roller 26 to fully contact the front inside surface 16 of the rail section 10. Notably, the change in roller contact improves the bearing contact area and thus reduces contact stresses. This greatly improves the operating efficiency. As shown in FIG. 12, the lower rollers 26, 28 are in full contact with the inside back surface 14 of the rail section 10 during both loaded and unloaded conditions.

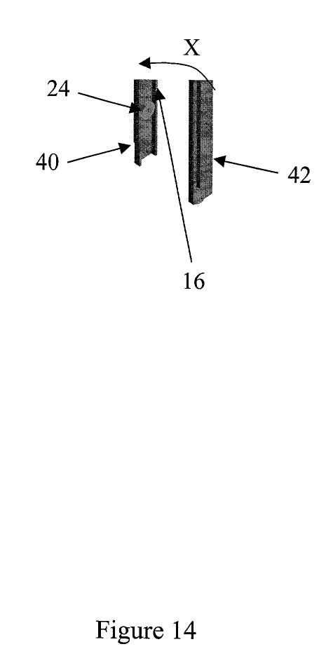

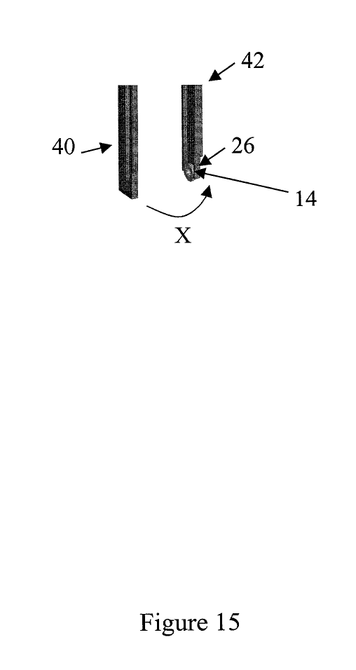

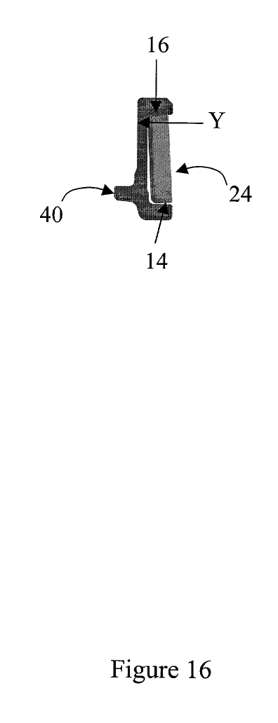

Referencing FIGS. 14-18, the lateral interaction of the rail section 10 of the present invention is described. The first upper and second lower rollers 22, 28 and the second upper and first lower rollers 24, 26 each form a couple in the rail section 10 when an offset load is applied to the carriage assembly 20. As shown in FIGS. 14 and 15, the second upper roller 24 acts against the front inner surface 16 of the first rail 40 and the first lower roller 26 acts on the back inner surface 14 of the second rail 42. Whether the upper lateral interaction occurs on the first rail 40 via roller 24 or the second rail 42 via roller 22 is determined by the direction of the offset load. For example, an offset load to the left of center creates a “clockwise” moment in the direction X as shown in FIGS. 15 and 16. In this example, the second upper roller 24 acts (i.e., has a point of contact) against the front inner corner of the first rail 40 at point Y as shown in FIGS. 16-18.

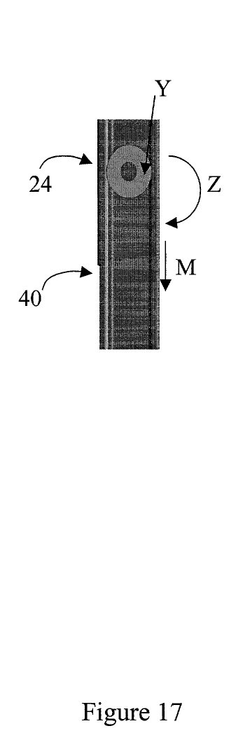

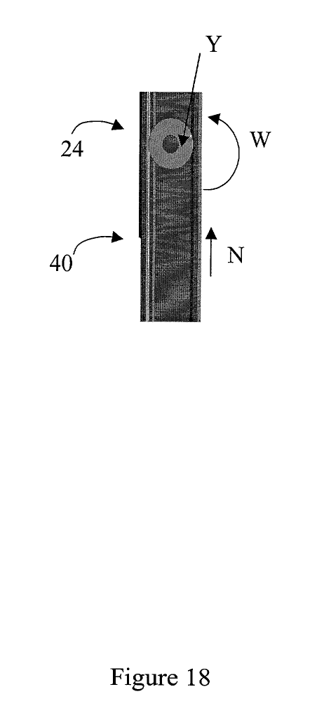

Notably, as shown in FIGS. 17 and 18, when the carriage assembly 20 (not shown) is raised or lowered with an offset load, the rotation of the rollers 22, 24, 26, 28 in the area of lateral contact and the translation of the rail section 10 relative to the rollers 22, 24, 26, 28 in the area of contact is in the same direction. Referring to FIG. 17, when the carriage assembly 20 (not shown) is raised, the rotation of the second upper roller 24 is in the clockwise direction Z and the translation of the first rail 40 relative to the second upper roller 24 is in the direction M. Thus, the direction of rotation of the second upper roller 24 at the point of contact Y is in the same direction as the translation of the first rail 40 in the direction M. Referring to FIG. 18, when the carriage assembly 20 (not shown) is lowered, the rotation of the second upper roller 24 is in the counterclockwise direction W and the translation of the first rail 40 relative to the second upper roller 24 is in the direction N. Thus, the direction of rotation of the second upper roller 24 at the point of contact Y is in the same direction as the translation of the first rail 40 in the direction N.

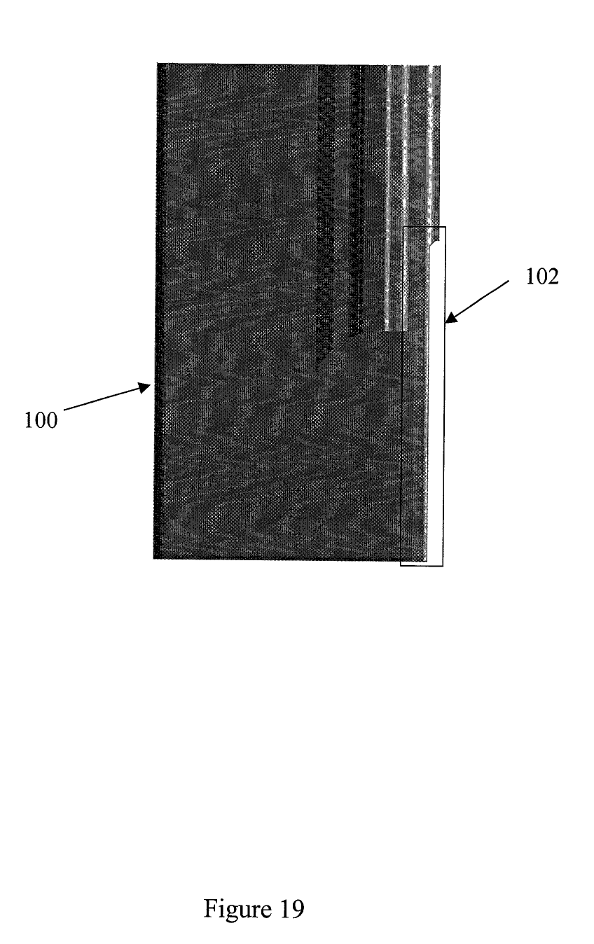

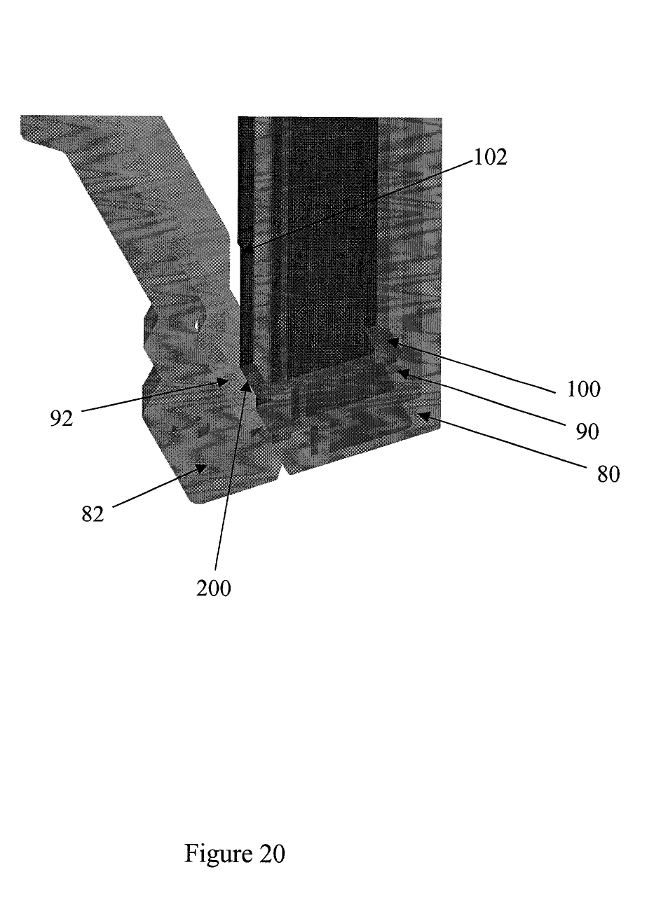

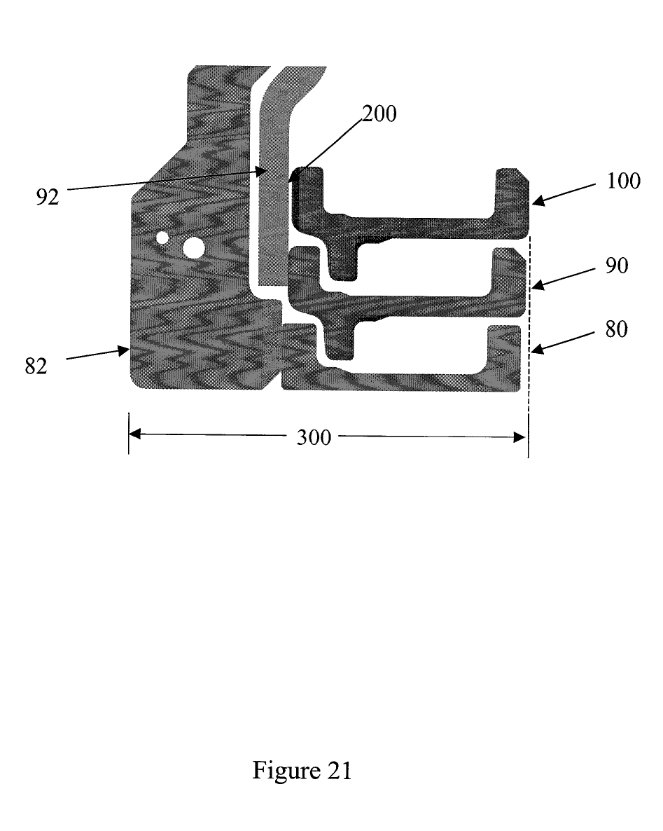

Another aspect of the present invention includes reducing the width of the inner rails to allow for integral stacking of the inner rails to minimize lost load of the mast thus minimizing the counterweight required on the body of the fork lift. Referring to FIGS. 19-21, the mast includes an outer rail 80 having an outer cross bar 82, a middle rail 90 having a middle cross bar 92, and inner rail 100. The width of the rear side of the inner rail 100 is reduced along the portion 102 of the inner rail 100 that is near the middle cross member 92 when the rails 80, 90, 100 are stacked. In this regard, a process of machining the inner rails 100 is used to reduce the effective thickness of the inner rail 100. As a result, the overall thickness 300 of the combination of the outer rail 80, middle rail 90, and inner rail 100 is reduced. Thus, the overall thickness of the mast is reduced. Notably, this reduction in effective thickness of the mast allows for a reduction in counterweight required on the body of the forklift to offset the lifted load.

The foregoing description of the present invention has been presented for purposes of illustration and description. The description is not intended to limit the invention to the form disclosed herein. Consequently, the invention and modifications commensurate with the above teachings and skill and knowledge of the relevant art are within the scope of the present invention. It is intended that the appended claims be construed to include all alternative embodiments as permitted by the prior art.

What is claimed is:

1. An improved mast for a fork lift comprising:
a) a carriage assembly comprising a first upper roller, a first lower roller, a second upper roller, a second lower roller and a front surface;
b) a first rail section comprising a first rail and a second rail positioned substantially parallel to each other, the first rail and second rail each comprising a back inner surface, a lateral inner surface and a front inner surface that are capable of operatively guiding said carriage assembly along a portion of the length of the rail section;
wherein the angle between said first upper roller and said front surface is greater than about 90.5°.

2. An improved mast for a fork lift as claimed in claim 1, wherein the angle between said second upper roller and said front surface is greater than about 90.5°.

3. An improved mast for a fork lift as claimed in claim 1, wherein the angle between said front inner surface of said first rail and said lateral inner surface is greater than about 90.5°.

4. An improved mast for a fork lift as claimed in claim 1, wherein the angle between said front inner surface of said second rail and said lateral inner surface is greater than about 90.5°.

5. An improved mast for a fork lift as claimed in claim 1, wherein the angle between said first upper roller and said front surface is in the range of about 92.5° to about 93.5°.

6. An improved mast for a fork lift as claimed in claim 1, wherein the angle between said second upper roller and said front surface is in the range of about 92.5° to about 93.5°.

7. An improved mast for a fork lift as claimed in claim 1, wherein the angle between said front inner surface of said first rail and said lateral inner surface is in the range of about 91.5° to about 92.5°.

8. An improved mast for a fork lift as claimed in claim 1, wherein the angle between said front inner surface of said second rail and said lateral inner surface is in the range of about 91.5° to about 92.5°.

9. An improved mast for a fork lift as claimed in claim 1, wherein the angle between said first upper roller and said front surface is about 93.0°.

10. An improved mast for a fork lift as claimed in claim 1, wherein the angle between said second upper roller and said front surface is about 93.0°.

11. An improved mast for a fork lift as claimed in claim 1, wherein the angle between said front inner surface of said first rail and said lateral inner surface is about 92.0°.

12. An improved mast for a fork lift as claimed in claim 1, wherein the angle between said front inner surface of said second rail and said lateral inner surface is about 92.0°.

13. An improved mast for a fork lift as claimed in claim 1, wherein a portion of the width of said first rail section is reduced.

14. An improved mast for a fork lift as claimed in claim 1, further comprising a second rail section comprising a first rail and a second rail positioned substantially parallel to each other and a cross member;
wherein the first rail section is operative connected to the second rail section to allow the first rail section to telescope inside the second rail section and out from the second rail section;
wherein a portion of the width of said first rail section is reduced that is near said cross member when the first rail section is telescoped inside the second rail section.

15. An improved mast for a fork lift comprising a carriage assembly having a first upper roller, a first lower roller, a second upper roller and a second lower roller;
wherein at least one of said first upper roller, said first lower roller, said second upper roller, and said second lower roller is canted.

16. An improved mast for a fork lift comprising:
a) a carriage assembly comprising a first upper roller, a first lower roller, a second upper roller, a second lower roller and a front surface;
b) a first rail section comprising a first rail and a second rail positioned substantially parallel to each other, the first rail and second rail each comprising a back inner surface, a lateral inner surface and a front inner surface that are capable of operatively guiding said carriage assembly along a portion of the length of the rail section;
wherein the angle between said front inner surface of said first rail and said lateral inner surface is greater than about 90.5°.

17. An improved mast for a fork lift as claimed in claim 16, wherein the angle between said first upper roller and said front surface is greater than about 90.5°.

18. An improved mast for a fork lift as claimed in claim 16, wherein the angle between said second upper roller and said front surface is greater than about 90.5°.

19. An improved mast for a fork lift as claimed in claim 16, wherein the angle between said front inner surface of said second rail and said lateral inner surface is greater than about 90.5°.

20. An improved mast for a fork lift as claimed in claim 16, wherein the angle between said first upper roller and said front surface is in the range of about 92.5° to about 93.5°.

21. An improved mast for a fork lift as claimed in claim 16, wherein the angle between said second upper roller and said front surface is in the range of about 92.5° to about 93.5°.

22. An improved mast for a fork lift as claimed in claim 16, wherein the angle between said front inner surface of said first rail and said lateral inner surface is in the range of about 91.5° to about 92.5°.

23. An improved mast for a fork lift as claimed in claim 16, wherein the angle between said front inner surface of said second rail and said lateral inner surface is in the range of about 91.5° to about 92.5°.

24. An improved mast for a fork lift as claimed in claim 16, wherein the angle between said first upper roller and said front surface is about 93.0°.

25. An improved mast for a fork lift as claimed in claim 16, wherein the angle between said second upper roller and said front surface is about 93.0°.

26. An improved mast for a fork lift as claimed in claim 16, wherein the angle between said front inner surface of said first rail and said lateral inner surface is about 92.0°.

27. An improved mast for a fork lift as claimed in claim 16, wherein the angle between said front inner surface of said second rail and said lateral inner surface is about 92.0°.

28. An improved mast for a fork lift as claimed in claim 16, wherein a portion of the width of said first rail section is reduced.

29. An improved mast for a fork lift as claimed in claim 16, further comprising a second rail section comprising a first rail and a second rail positioned substantially parallel to each other and a cross member;
wherein the first rail section is operative connected to the second rail section to allow the first rail section to telescope inside the second rail section and out from the second rail section;
wherein a portion of the width of said first rail section is reduced that is near said cross member when the first rail section is telescoped inside the second rail section.

30. An improved mast for a fork lift comprising a carriage assembly having a first upper roller, a first lower roller, a second upper roller, a second lower roller and a front surface;
wherein at least one of said first upper roller, said first lower roller, said second upper roller, and said second lower roller is angled relative to said front surface.

31. An improved mast for a fork lift comprising a rail section that includes a first rail and a second rail positioned substantially parallel to each other, the first rail and second rail each comprising a back inner surface, a lateral inner surface and a front inner surface;
wherein the front inner surface of said first rail and said second rail are angled relative to said lateral inner surface.

32. An improved mast for a fork lift as claimed in claim 1, wherein the back inner surface of said first rail and said second rail is substantially straight.

33. An improved mast for a fork lift comprising:
a carriage assembly comprising a first upper roller, a first lower roller, a second upper roller, a second lower roller and a front surface;
an inner rail section comprising a first rail and a second rail positioned substantially parallel to each other, the first rail and second rail each comprising a back inner surface, a lateral inner surface and a front inner surface that are capable of operatively guiding said carriage assembly along at least a portion of the length of said inner rail section;
a middle section comprising a first rail and a second rail positioned substantially parallel to each other, wherein said inner rail section is operative connected to said middle rail section to allow the inner rail section to telescope inside said middle rail section and out from said middle rail section;
an outer rail section comprising a first rail and a second rail positioned substantially parallel to each other; wherein said middle rail section is operative connected to said outer rail section to allow the middle rail section to telescope inside said outer rail section and out from said outer rail section;
wherein the first upper roller and second upper roller on said carriage assembly are positioned relative to said front surface at an angle greater than about 90.5°;
wherein the front inner surface of said first rail and said second rail of said inner rail section are positioned relative said front surface at an angle about 90.0°.

34. An improved mast for a fork lift comprising:
a first rail, wherein said first rail comprises a first inner surface including a first back inner surface, a first front inner surface substantially opposite said first back inner surface, a first lateral inner surface that connects said first back inner surface and said first front inner surface;
a second rail positioned substantially parallel to said first rail, wherein said second rail comprises a second inner surface including a second back inner surface, a second front inner surface substantially opposite said second back inner surface, and a second lateral inner surface that connects said second back inner surface and said second front inner surface;
a carriage assembly comprising a first upper roller, a second upper roller positioned substantially opposite said first upper roller, a first lower roller, a second lower roller positioned substantially opposite said first lower roller, and a front surface;
wherein said first upper roller and said first lower roller of said carriage assembly are operatively guided by said first inner surface of said first rail, and said second upper roller and said second lower roller of said carriage assembly are operatively guided by said second inner surface of said second rail, to cause said front surface of said carriage assembly to move along at least a portion of the length said first rail and said second rail;
wherein the intersection of said first front surface and said first lateral surface forms a first angle between said first front surface and said first lateral surface.
wherein said first angle is greater than about 90.5°.

35. The improved mast of claim 34, wherein said first angle is in the range of about 91.5° to about 92.5°.

36. The improved mast of claim 34, wherein said first angle is about 92.0°.

37. The improved mast of claim 34, wherein the axis of rotation of said first upper roller is not substantially parallel to said front surface of said carriage assembly.

38. The improved mast of claim 34, wherein the rotation of said first upper roller defines a first plane;
wherein the intersection of said front surface of said carriage assembly and said first plane forms a second angle between said first front surface of said carriage assembly and said first plane;
wherein said second angle is greater than about 90.5°.

39. The improved mast of claim 38, wherein said second angle is in the range of about 92.5° to about 93.5°.

40. The improved mast of claim 38, wherein said second angle is about 93.0°.

41. An improved mast for a fork lift comprising:
a first rail, wherein said first rail comprises a first inner surface including a first back inner surface, a first front inner surface substantially opposite said first back inner surface, a first lateral inner surface that connects said first back inner surface and said first front inner surface;
a second rail positioned substantially parallel to said first rail, wherein said second rail comprises a second inner surface including a second back inner surface, a second front inner surface substantially opposite said second back inner surface, and a second lateral inner surface that connects said second back inner surface and said second front inner surface;
a carriage assembly comprising a first upper roller, a second upper roller positioned substantially opposite said first upper roller, a first lower roller, a second lower roller positioned substantially opposite said first lower roller, and a front surface;
wherein said first upper roller and said first lower roller of said carriage assembly are operatively guided by said first inner surface of said first rail, and said second upper roller and said second lower roller of said carriage assembly are operatively guided by said second inner surface of said second rail, to cause said front surface of said carriage assembly to move along at least a portion of the length said first rail and said second rail;
wherein the intersection of said first front surface and said first lateral surface forms a first angle between said first front surface and said first lateral surface.
wherein the rotation of said first upper roller defines a first plane;
wherein the intersection of said front surface of said carriage assembly and said first plane forms a second angle between said first front surface of said carriage assembly and said first plane;
wherein the relative difference between said first angle and said second angle is greater than about 0.5°.

42. An improved mast as claimed in claim 41, wherein the relative difference between said first angle and said second angle is in the range of about 0.5° to about 3.0°.

43. An improved mast as claimed in claim 41, wherein the relative difference between said first angle and said second angle is about 1.0°.

44. An improved mast for a fork lift comprising:
a first rail, wherein said first rail comprises a first inner surface including a first back inner surface, a first front inner surface substantially opposite said first back inner surface, a first lateral inner surface that connects said first back inner surface and said first front inner surface;
a second rail positioned substantially parallel to said first rail, wherein said second rail comprises a second inner surface including a second back inner surface, a second front inner surface substantially opposite said second back inner surface, and a second lateral inner surface that connects said second back inner surface and said second front inner surface;
a carriage assembly comprising a first upper roller, a second upper roller positioned substantially opposite said first upper roller, a first lower roller, a second lower roller positioned substantially opposite said first lower roller, and a front surface;
wherein said first upper roller and said first lower roller of said carriage assembly are operatively guided by said first inner surface of said first rail, and said second upper roller and said second lower roller of said carriage assembly are operatively guided by said second inner surface of said second rail, to cause said front surface of said carriage assembly to move along at least a portion of the length said first rail and said second rail;
wherein the rotation of said first upper roller defines a first plane;
wherein the intersection of said front surface of said carriage assembly and said first plane forms a second angle between said first front surface of said carriage assembly and said first plane;
wherein said second angle is greater than about 90.5°.

45. The improved mast of claim 44, wherein said second angle is in the range of about 92.5° to about 93.5°.

46. The improved mast of claim 44, wherein said second angle is about 93.0°.
